(19) United States
(12) Patent Application Publication
(10) Pub. No.: US 2013/0208380 A1
(43) Pub. Date: Aug. 15, 2013

(54) TRANSIENT CONTROL TECHNOLOGY CIRCUIT

(71) Applicant: TRANSTECTOR SYSTEMS, INC., (US)

(72) Inventors: Mark L. Hendricks, Hayden, ID (US); Eric Nguyen, Hayden, ID (US)

(73) Assignee: TRANSTECTOR SYSTEMS, INC., HAYDEN, ID (US)

(21) Appl. No.: 13/764,588

(22) Filed: Feb. 11, 2013

Related U.S. Application Data
(60) Provisional application No. 61/597,631, filed on Feb. 10, 2012.

(51) Int. Cl. H02H 3/02

(52) U.S. Cl. CPC H02H 3/021
USPC 361/56

(57) ABSTRACT

An active surge suppression or protection circuit for protecting hardware or equipment from electrical surges. During operation when no surge condition is present, the circuit passes signals from an input source to a connected load along a signal path. When a surge is present, the circuit automatically senses and diverts the surge away from the signal path. A switching component is provided along the signal path for either allowing transmission or preventing transmission of a signal along the signal path. Upon diverting the surge, the circuit automatically changes the switching component from a closed state (for allowing transmission) to an open state (for preventing transmission). After the surge has passed, the circuit automatically changes the switching component from the open state to the closed state. Other automatic circuit behaviors may also be achieved in response to the diversion of a surge condition from the signal path.

### CROSS REFERENCE TO RELATED APPLICATIONS

This application claims the benefit and priority of U.S. Provisional Application No. 61/597,631 entitled Transient Control Technology Circuit, filed on Feb. 10, 2012, the entire contents of which are hereby incorporated by reference herein.

### BACKGROUND

1. Field

The present disclosure relates generally to surge protection circuits and improvements thereof. More particularly, the present disclosure relates to automatically resettable surge protection circuits and improvements thereof.

2. Description of the Related Art

Communications equipment, computers, home stereo amplifiers, televisions and other electronic devices are increasingly manufactured using a variety of electronic components that are vulnerable to damage from electrical energy surges. Surge variations in power and transmission line voltages, as well as noise, can change the operating frequency range of connected equipment and severely damage or destroy electronic devices. Electronic devices impacted by these surge conditions can be very expensive to repair or replace. Therefore, a cost effective way to protect these devices and components from power surges is needed.

Surge protectors help protect electronic equipment from damage due to the large variations in the current and voltage resulting from lightning strikes, switching surges, transients, noise, incorrect connections or other abnormal conditions or malfunctions that travel across power or transmission lines. Such protection schemes are particularly important in the aerospace industry where electronic reliability is often subject to heightened scrutiny due to the increased safety concerns inherent in airline industry operations. The effects of power surges from overvoltages or overcurrents upon commercial or military aircraft systems can cause dangerous disruptions of the various systems aboard the aircraft and must be mitigated for safe airline travel. As the number of electronic systems continues to increase on modern aircraft, and especially for flight critical electronics that impact air travel characteristics or navigational systems, it is important that such systems are not susceptible to damage or malfunction due to a power surge propagating through the system. In an effort to reduce these risks, protection circuits or devices have been incorporated as part of aircraft electrical systems to prevent the propagation of power surges through the electronics or other electrical equipment.

However, conventional protection circuits typically employ fuses that are configured to open during an overcurrent fault condition. Other protection circuits use passive surge protection elements in a series or parallel configuration. Once these fuses or protection elements have opened or otherwise tripped to prevent propagation of a surge, the connected electrical system exists in a protected state, but the circuit can cause faults in a connected system of the aircraft. Indeed, due to the interoperability of many systems with each other for proper aircraft functionality or operation, the propagation of a fault from a first system to a second system due to a surge protection scheme may be extremely undesirable and damaging to safe operation of the aircraft.

Therefore, an active surge protection system or circuit is desirable that can automatically sense an overvoltage or overcurrent condition, actively respond to the overvoltage or overcurrent condition and automatically reset when the overvoltage or overcurrent condition returns to a normal state. The surge protection system should provide power surge protection such that a fault in one system does not propagate into or cause a fault in another connected system. In addition, the surge protection system or circuit would desirably be inexpensive to manufacture and lightweight while providing optimum coordination or behavior of its surge protection elements.

### SUMMARY

An apparatus and method for automatically sensing a surge condition and configured to automatically reset when the surge condition has dissipated is disclosed. In one implementation, an automatic surge sensing protection device may include a housing defining a cavity therein, an input port connected to the housing and an output port connected to the housing. A first transistor may be positioned within the housing and have a first terminal, a second terminal and a third terminal, the first terminal connected to the input port and the second terminal connected to the output port. The first transistor may be configured to automatically switch from a conducting configuration to a non-conducting configuration, the conducting configuration for allowing signal propagation from the first terminal to the second terminal and the non-conducting configuration for preventing signal propagation from the first terminal to the second terminal. At least one resistor may be positioned within the housing and connected to the third terminal of the first transistor for biasing the first transistor. At least one diode may be positioned within the housing and connected to the input port for diverting a surge signal from the input port to a ground. A second transistor may be connected to the third terminal of the first transistor for controlling the switching of the first transistor from the conducting configuration to the non-conducting configuration.

### BRIEF DESCRIPTION OF THE DRAWINGS

Other systems, methods, features, and advantages of the present disclosure will be or will become apparent to one of ordinary skill in the art upon examination of the following figures and detailed description. It is intended that all such additional systems, methods, features, and advantages be included within this description, be within the scope of the present disclosure, and be protected by the accompanying claims. Component parts shown in the drawings are not necessarily to scale, and may be exaggerated to better illustrate the important features of the present disclosure. In the drawings, like reference numerals designate like parts throughout the different views, wherein:

FIG. 1 is a schematic circuit diagram of a transient control technology surge protection circuit with dual power inputs and configured to automatically sense a surge and reset after the surge in accordance with an embodiment of the present invention;

FIG. 2 is a schematic circuit diagram of a transient control technology surge protection circuit with single power input and a positive polarity and configured to automatically sense a surge and reset after the surge in accordance with an embodiment of the present invention; and

FIG. 3 is a schematic circuit diagram of a transient control technology surge protection circuit with single power input and a negative polarity and configured to automatically sense a surge and reset after the surge in accordance with an embodiment of the present invention.

### DETAILED DESCRIPTION

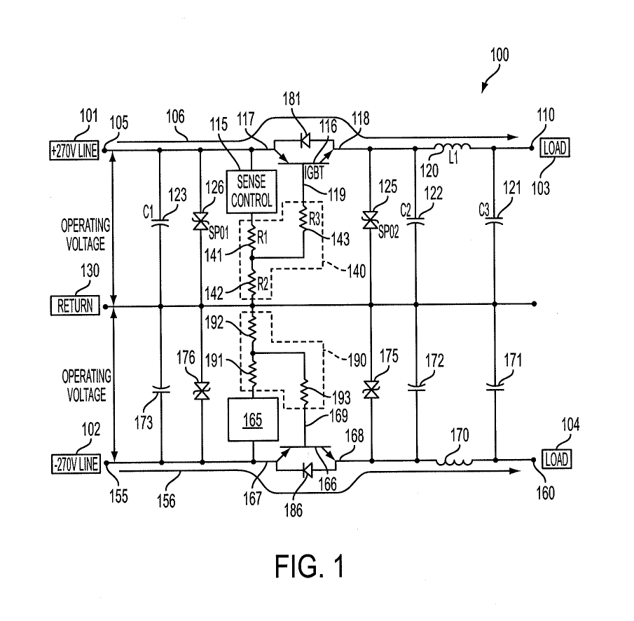

Referring to FIG. 1, a schematic circuit diagram of a transient control technology surge protection circuit 100 is shown. The surge protection circuit 100 operates to protect any connected loads (103, 104) from an electrical surge that could otherwise damage or destroy the loads (103, 104). The protected loads (103, 104) can be any form of electric equipment, for example electrical units aboard an aircraft, communications equipment, cell towers, base stations, PC computers, servers, network components or equipment, network connectors or any other type of surge sensitive electronic equipment. The surge protection circuit 100 includes a number of different electrical components, such as capacitors, resistors, inductors, diodes and IGBTs. For illustrative purposes, the surge protection circuit 100 will be described with reference to specific capacitor, resistor, inductor, diode or IGBT values and configurations to achieve specific surge protection or energy storage capabilities. However, other specific capacitor, resistor, inductor, diode or IGBT values or configurations may be used to achieve other electrical, surge protection or energy storage characteristics. Similarly, although the preferred configuration or implementation is shown with particular capacitor, resistor, inductor, diode and IGBT circuit elements and values, it is not required that the exact circuit elements or values described be used in the present disclosure. Thus, the capacitors, resistors, inductors, diodes and IGBTs are merely used to illustrate an implementation of the present disclosure and not to limit the present disclosure.

The surge protection circuit 100 may be implemented as a surge protection or suppression device. The surge protection circuit 100 includes a positive input port 105 and a positive output port 110 for connecting the surge protection device between a positive voltage source 101 and the load 103. Similarly, the surge protection circuit 100 includes a negative input port 155 and a negative output port 160 for connecting the surge protection device between a negative voltage source 102 and the load 104. The voltage sources (101, 102) may be 270 Vdc, 20 A power sources. In one implementation, the surge protection circuit 100 may be formed as part of or included within a housing or other enclosure for allowing a user to physically connect the surge protection or suppression device to the voltage sources (101, 102) and the loads (103, 104).

The input ports (105, 155) and output ports (110, 160) are configured to mate or otherwise interface with signal carrying conductors, for example, coaxial cables. In some implementations, the surge protection circuit 100 may be configured to operate bi-directionally such that a surge suppression device incorporating the circuit may have its input ports function as output ports or vice versa. By electrically connecting the surge suppression device having the surge protection circuit 100 along a conductive path or transmission line between the power sources (101, 102) and the connected loads (103, 104), an electrical surge that could otherwise damage or destroy the connected loads (103, 104) will instead be dissipated through the surge protection device. Conventional surge protection methods operate only to lower the voltage level presented to any connected equipment by diversion of surge current through a surge element (e.g., a silicon avalanche diode) along an alternate, parallel surge path. A portion or remnant of the surge is still presented at the connected equipment, however, due to the let through voltage or let through energy of the surge element. The surge protection circuit 100 operates to block all of this surge voltage or current via incorporation of a switching component (e.g., an IGBT) in addition to surge current diversion, as described in further detail herein. Thus, the surge protection circuit 100 does not merely lower surge voltage levels presented to systems or equipment to be protected, but rather completely blocks all surge voltage and diverts all surge current from propagating to the connected systems or equipment, resulting in zero surge energy propagation to the connected systems or equipment.

The surge protection circuit 100 incorporates a signal path 106 extending from the positive input port 105 to the positive output port 110. Similarly, a signal path 156 extends from the negative input port 155 to the negative output port 160. A ground or return conductor 130 is also included as part of the surge protection circuit 100. The return conductor 130 may be a signal line configured to be connected to an exterior ground via a connector port or may be a part of an exterior housing of the surge protection device. At each input port (105, 155) each power source (101, 102) is shown. At each output port (110, 160) each connected load (103, 104) is shown. In the absence of any further surge protection circuit elements, a power surge from the input ports (105, 155) would propagate along their respective signal paths (106, 156) to the output ports (110, 160) and potentially interfere with, cause damage to or destroy the connected loads (103, 104).

The surge protection circuit 100 includes various circuit elements connected between the input ports (105, 155), the output ports (110, 160) and the return conductor 130 to prevent a surge from interfering with the connected loads (103, 104). Not only are these circuit elements configured to automatically divert the surge before it reaches the connected loads (103, 104), but they are also configured to modify and automatically reset a signal path of the surge protection circuit 100 based upon operation of the surge protection circuit 100 under non-surge or surge conditions. Thus, a fault in the surge protection circuit 100 due to the presence of a surge will not propagate into or cause a fault in another connected system.

Turning more specifically to the various components used in the surge protection circuit 100, three capacitors (121, 122, 123) are provided, one end of each of the capacitors (121, 122, 123) electrically connected with the return conductor 130 and the other end connected to an electrical node along the signal path 106 extending from the positive input port 105 to the positive output port 110. An inductor 120 is also connected along the signal path 106. The three capacitors (121, 122, 123) and the inductor 120 are elements of a pi filter to account for any back electromagnetic field (EMF) effects stemming from power supply sources, inductive motor loads, or other interfering devices connected at the input port 105 or the load 103. Similarly, three capacitors (171, 172, 173) are connected between the return conductor 130 and an electrical node along the signal path 156 extending from the negative input port 155 to the negative output port 160. An inductor 170 is also connected along the signal path 156 to form a pi filter with the three capacitors (171, 172, 173) for similar reasons to those discussed above.

The surge protection circuit 100 also includes a first insulated gate bipolar transistor (IGBT) 116. The first IGBT 116 is a three terminal device with one terminal 117 (e.g., the collector) connected to the positive input port 105 and a second terminal 118 (e.g., the emitter) connected to the positive output port 110. When in a first, conducting configuration, the IGBT 116 allows a signal present on the positive input port 105 to propagate to the positive output port 110 along the signal path 106. A plurality of biasing resistors, or current divider 140, including a first resistor 141, a second resistor 142, and a third resistor 143, are connected to a third terminal 119 (e.g., the gate) of the IGBT 116 for biasing the IGBT 116. The values of the plurality of resistors 140 are derived from the target operating voltage and load current of the voltage sources (101, 102). The first resistor 141, the second resistor 142 and the third resistor 143 form a current divider network to set the bias level and/or thresholds for operating the IGBT 116 in a second, non-conductive configuration when the current through the third resistor 143 (i.e., the gate current) is high enough to drive the IGBT 116 into its saturation region. In one implementation, the first resistor 141 may be about 65 ohms, the second resistor 142 may be about 2.7 k ohms and the third resistor 143 may be about 1 ohm.

Similarly, a second IGBT 166 with three terminals is provided, one terminal 167 connected to the negative input port 155 and a second terminal 168 connected to the negative output port 160. The same or similar to the description above for the first IGBT 116, the second IGBT 166 has a first, conducting configuration for allowing a signal present on the negative input port 155 to propagate along the signal path 156 to the negative output port 160. A plurality of biasing resistors, or current divider 190, including a fourth resistor 191, a fifth resistor 192 and a sixth resistor 193, are connected to a third terminal 169 of the second IGBT 166 for biasing the IGBT 166, the same or similar to the discussion above for IGBT 116. The resistors 190 may have the same values as the respective resistors 140, as discussed above. Flyback diodes (181, 186) may also be provided across the IGBTs (116, 166), respectively, for providing additional circuit protection when the voltage across the IGBTs (116, 166) is suddenly reduced or removed.

Zener diodes (126, 125) are connected between the return conductor 130 (i.e., ground) and an electrical node along the signal path 106. Similarly, zener diodes (176, 175) are connected between the return conductor 130 and an electrical node along the signal path 156. When a surge signal is present along the signal path 106, the zener diodes (126, 125) shunt at least some of the surge energy to the return conductor 130 before it can propagate to and potentially damage the load 103. Likewise, when a surge signal is present along the signal path 156, the zener diodes (176, 175) shunt at least some of the surge energy to the return conductor 130 before it can propagate to and potentially damage the load 104. The zener diodes (126, 125, 176, 175) may have any desired threshold voltage and may be selected based on 10% of the maximum continuous operating voltage of the voltage sources (101, 102) or selected based upon a preferred or utilized surge diversion technology (e.g., Silicon Avalanche Diodes (SADs), Metal Oxide Varistors (MOVs), Gas Discharge Tubes (GDTs), etc.) for withstanding a desired surge amount for a given circuit.

The combination of the zener diodes (126, 125, 176, 175) and the IGBTs (116, 166) provide reliable protection of equipment when subjected to power surge waveforms. By utilizing the zener diodes (126, 125, 176, 175) and the IGBTs (116, 166) together for managing surge energy, voltage let through that might otherwise introduce remnants of the surge through to any connected equipment if only the zener diodes (126, 125, 176, 175) were present is instead completely eliminated. Surge current flows entirely along a diverted surge path through one or more of the zener diodes (126, 125, 176, 175) because one or more of the IGBTs (116, 166) provides an open circuit for blocking the path of the surge to the connected equipment. In this manner, surge voltage or energy is not merely lowered, but nullified so far as any connected equipment is concerned. In one implementation, the power surge waveform to be managed may be a 2000V, 2000 A 40/120 μs pulses per DO160 Waveform 5 A requirements. However, an alternative implementation may be designed to accommodate any desired power surge waveform. In an alternative implementation, other circuit elements or components may be utilized for any of the zener diodes (126, 125, 176, 175) such as SADs, MOVs, GDTs, etc. Similarly, alternative switching components (e.g., relays, switches, transistors, flip-flops, contactors, etc.) may be utilized in place of or in addition to the IGBTs (116, 166) in certain implementations.

When a surge signal is introduced at the positive input port 105 and diverted to the return conductor 130, operation of the IGBT 116 changes from a first, conducting configuration to a second, non-conducting configuration. At least a portion of the surge signal is permitted to conduct through the sense control 115 and to the plurality of resistors 140. The sense control 115 may be any circuit element or elements that does not conduct when presented with a non-surge signal, but begins to conduct when presented with a surge signal. When in the second, non-conducting configuration due to the biasing from the plurality of resistors 140, the IGBT 116 prevents a signal present on the positive input port 105 from propagating to the positive output port 110 along the signal path 106.

Similar operation occurs when a surge signal present on the negative input port 155 is diverted to the return conductor 130. Operation of the second IGBT 166 changes to a second, non-conducting configuration due to biasing from the plurality of resistors 190 when at least a portion of a surge signal is passed through a sense control 165. The second, non-conducting configuration of the second IGBT 166 prevents a signal at the negative input port 155 from propagating along the signal path 156 to the negative output port 160. The IGBTs (116, 166) may be capable of withstanding about 1,000V across their first terminals (117, 167) to second terminals (118, 168) and capable of passing about 40 A of current. When in the first, conducting configuration, the IGBTs (116, 166) exhibit a low continuous power loss (e.g., about 2.1 VCE).

In this manner, not only is a surge signal on the input ports (105, 155) automatically sensed and directed or diverted away from the connected loads (103, 104), but the signal paths (106, 156) themselves leading from the input ports (105, 155) to the output ports (110, 160) are automatically opened via the IGBTs (116, 166) in response to the shunting of the surge signal to ground, thus preventing or mitigating the transmission of faults from part of a system to another in the event of a surge condition. After the surge signal is no longer present on the input ports (105, 155), the signal paths (106, 156) are automatically closed again via the IGBTs (116, 166). In an alternative implementation, any of a variety of signal pathways may be automatically changed as desired or designed in response to the sensing and/or diversion of a surge signal to a ground and then automatically reset after the surge signal is no longer present.

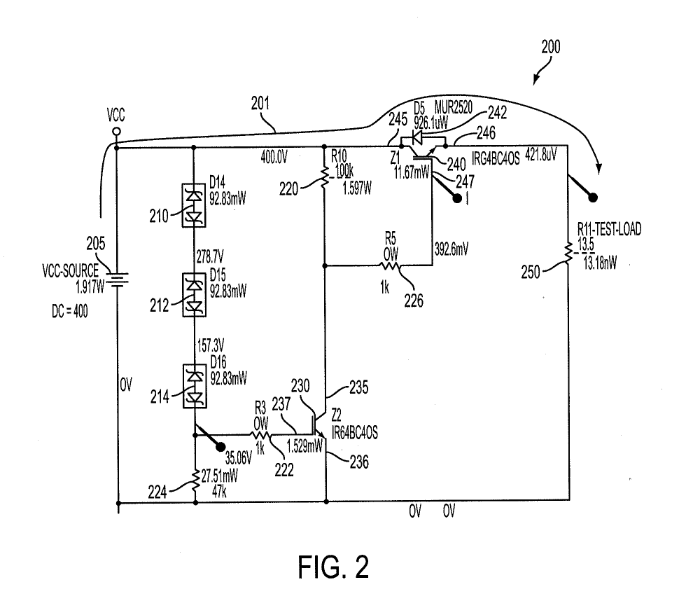

Turning next to FIG. 2, a schematic circuit diagram of a transient control technology surge protection circuit 200 with single power input configured to automatically sense a surge and reset after the surge is shown, configured as a positive polarity circuit. A power source 205 is connected to a load 250 through a variety of electronic components, as discussed in greater detail herein. In one implementation, the variety of electronic components may be physically mounted to a printed circuit board and configured to connect with the power source 205 and/or the load 250. In certain implementations, the electronic components may be contained within a housing or other enclosure with an input port for connecting with the power source 205 and an output port for connecting with the load 250. Certain structure or functional aspects of the surge protection circuit 200 may be or operate the same or similar to structure or functional aspects of the schematic circuit diagram 100, as previously described.

Turning more specifically to the variety of electronic components used in the surge protection circuit 200, a transistor 240 (e.g., an IGBT) with three connection terminals (245, 246, 247) is provided for controlling a signal path, as discussed in more detail herein. A power source 205 or other signal source is connected to the transistor 240 at a first connection terminal 245 of the transistor 240. A load 250 is connected to the transistor 240 at a second connection terminal 246 of the transistor 240. Thus, a signal path 201 is formed from the power source 205, through the transistor 240 and to the connected load 250. During normal operation (e.g., in the absence of a surge condition), the transistor 240 is in a conducting configuration and signals are allowed to conduct through the transistor 240 along the signal path 201. However, upon a surge condition, the transistor 240 changes to a non-conducting configuration and signals are prevented from conducting through the transistor 240 along the signal path 201.

Resistors (220, 226) are connected to a third terminal 247 of the transistor 240 and to the power source 205 for helping bias the transistor 240 in the conductive configuration or the non-conductive configuration. Resistor 220 allows current to flow from the power source 205 and into the resistor 226 when a surge condition is not present to bias the transistor 240 into the conducting configuration such that signals or power may flow from the power source 205 to the load 250 along the signal path 201.

Zener diodes (210, 212, 214) are connected to the power source 205 for diverting a surge introduced into the signal path 201. Resistors (224, 222) are connected to the zener diodes (210, 212, 214). A second transistor 230 with three connection terminals (235, 236, 237) is also provided for controlling the switching of the first transistor 240 from the conducting configuration to the non-conducting configuration or vice versa. The first terminal 235 of the second transistor 230 is connected to the third terminal 247 of the first transistor 240 through the resistor 226. The second terminal 236 of the second transistor 230 is connected to a ground or a return. The third terminal 237 of the second transistor 230 is connected to the resistor 222. Thus, when the surge encounters the zener diodes (210, 212, 214), the zener diodes (210, 212, 214) sense the overvoltage condition and begin to conduct the surge current into the resistor 224. Current also flows into the resistor 222 and drives the second transistor 230 (e.g., an IGBT) so that it begins to conduct between its first terminal 235 and its second terminal 236.

When the second transistor 230 begins to conduct, current from the resistor 220 flows through the second transistor 230 instead of through the resistor 226. Thus, the first transistor 240 is changed from its normal, conducting configuration to a non-conducting configuration. A flyback diode 242 is provided across the first transistor 240 for providing additional protection when the voltage across the first transistor 240 is suddenly reduced or removed, similar to as discussed above for FIG. 1. In an alternative implementation, a flyback diode may also be provided across the second transistor 230 in the same or similar manner.

Resistor 220 may be a 100 k ohm resistor and resistor 224 may be a 47 k ohm resistor. Resistors (226, 222) may be 1 k ohm resistors. The first and second transistors (240, 230) may both be IRG4BC40S IGBTs. The first transistor 240 may be selected to handle a desired voltage and/or current to provide optimum power transfer along the signal path 201 with low losses. An IGBT may be used due to its fast switching capabilities and high power handling capacity, but may be more expensive and heavier than alternative switching components. The second transistor 230 may be chosen to be the same electrical component as the first transistor 240 to minimize the number of unique electrical parts within the circuit 200 or may be selected to be another transistor or switching device chosen to accommodate the signals presented to it during operation. The zener diodes (210, 212, 214) may be supplemented or replaced with other surge diverting elements (e.g., SADs, MOVs, GDTs, etc.). Different surge diverting elements may provide alternative surge diversion circuit performance (e.g., a GDT may provide a longer delay before the surge is diverted).

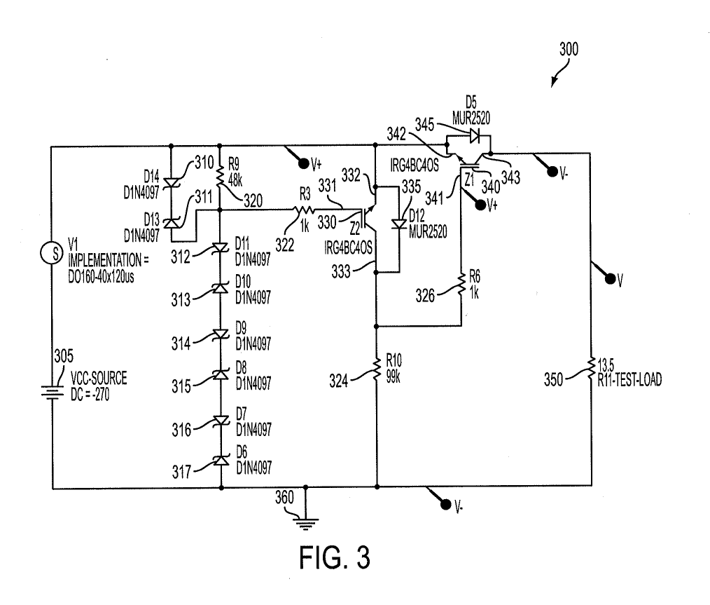

Turning next to FIG. 3, a schematic circuit diagram of a transient control technology surge protection circuit 300 with single power input configured to automatically sense a surge and reset after the surge is shown. The surge protection circuit 300 is a negative polarity circuit that operates similar to the surge protection circuit 200 shown in FIG. 2, which is a positive polarity circuit. A power source 305 is connected to a load 350 through a variety of electronic components, as discussed in greater detail herein. In one implementation, the variety of electronic components may be physically mounted to a printed circuit board and configured to connect with the power source 305 and/or the load 350. In certain implementations, the electronic components may be contained within a housing or other enclosure with an input port for connecting with the power source 305 and an output port for connecting with the load 350. Certain structure or functional aspects of the surge protection circuit 300 may be or operate the same or similar to structure or functional aspects of the schematic circuit diagram 100, as previously described.

Turning more specifically to the variety of electronic components used in the surge protection circuit 300, a transistor 340 (e.g., an IGBT) with three connection terminals (342, 343, 341) is provided for controlling a signal path, as discussed in more detail herein. A power source 305 or other signal source is connected to the transistor 340 at a first connection terminal 342 of the transistor 340. A load 350 is connected to the transistor 340 at a second connection terminal 343 of the transistor 340. During normal operation (e.g., in the absence of a surge condition), the transistor 340 is in a conducting configuration and signals are allowed to conduct through the transistor 340. However, upon a surge condition, the transistor 340 changes to a non-conducting configuration and signals are prevented from conducting through the transistor 340.

Resistors (326, 324) are connected to a third terminal 341 of the transistor 340 and to a ground 360 for helping bias the transistor 340 in the conductive configuration or the non-conductive configuration. Resistor 324 allows current to flow from the power source 305 and into the resistor 326 when surge conditions are not present to bias the transistor 340 into the conducting configuration such that signals or power may flow from the power source 305 to the load 350.

Zener diodes (310-317) are connected to the power source 305 for diverting a surge. Resistors (320, 322) are connected to the zener diodes (310-317). A second transistor 330 with three connection terminals (332, 333, 331) is also provided for controlling the switching of the first transistor 340 from the conducting configuration to the non-conducting configuration or vice versa. The second terminal 333 of the second transistor 330 is connected to the third terminal 341 of the first transistor 340 through the resistor 326. The first terminal 332 of the second transistor 330 is connected to the power source 305. The third terminal 331 of the second transistor 330 is connected to the resistor 322. Thus, when the surge encounters the zener diodes (310, 311), the zener diodes (310, 311) sense the overvoltage condition and begin to conduct the surge current into the resistor 320. Current also flows into the resistor 322 and drives the second transistor 330 (e.g., an IGBT) so that it begins to conduct between its first terminal 332 and its second terminal 333.

When the second transistor 330 begins to conduct, current from the resistor 324 flows through the second transistor 330 instead of through the resistor 326. Thus, the first transistor 340 is changed from its normal, conducting configuration to a non-conducting configuration. A flyback diode 345 is provided across the first transistor 340 for providing additional protection when the voltage across the first transistor 340 is suddenly reduced or removed, similar to as discussed above for FIG. 1. A flyback diode 335 is also provided across the second transistor 330 in the same or similar manner.

Resistor 324 may be a 99 k ohm resistor and resistor 320 may be a 48 k ohm resistor. Resistors (326, 322) may be 1 k ohm resistors. The first and second transistors (340, 330) may both be IRG4BC40S IGBTs. The first transistor 340 may be selected to handle a desired voltage and/or current to provide optimum power transfer with low losses. An IGBT may be used due to its fast switching capabilities and high power handling capacity, but may be more expensive and heavier than alternative switching components. The second transistor 330 may be chosen to be the same electrical component as the first transistor 340 to minimize the number of unique electrical parts within the circuit 300 or may be selected to be another transistor or switching device chosen to accommodate the signals presented to it during operation. The zener diodes (310-317) may be supplemented or replaced with other surge diverting elements (e.g., SADs, MOVs, GDTs, etc.). Different surge diverting elements may provide alternative surge diversion circuit performance (e.g., a GDT may provide a longer delay before the surge is diverted).

The surge protection circuits 100, 200, or 300 described above may be modified or alternatively designed with differing circuit element values or with different, additional, or fewer circuit elements to achieve the same or similar functionality. The surge protection circuits 100, 200, or 300 may also be scaled for application of any desired voltage or current operating levels. The surge protection circuits 100, 200, or 300 may be designed with components to facilitate AC functionality or DC functionality. As such, the surge protection circuits 100, 200, or 300 may be configured for ranges of typical or commonly expected surge levels or may be designed and constructed as a custom configuration to meet a particular system or setup. By utilizing a small number of electrical components to achieve the desired functionality, manufacturing cost may be reduced and the weight of an apparatus incorporating the circuit kept low.

The circuit elements incorporating the surge protection circuits 100, 200, or 300 may be discrete elements positioned within an enclosure or housing and/or may be mounted or electrically connected with a printed circuit board. An enclosure used may have input and/or output ports for allowing user-installation of the circuit to their own systems or equipment. In certain implementations, the enclosure may be a connector, the various circuit elements integrated within the connector.

Exemplary implementations of the present disclosure have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such implementations that reasonably fall within the scope of the advancement to the art hereby contributed, and that that scope shall not be restricted, except in light of the appended claims and their equivalents.

What is claimed is:

1. An automatic surge sensing protection device comprising:
an input port;
an output port;
a first transistor having a first terminal, a second terminal and a third terminal, the first terminal connected to the input port and the second terminal connected to the output port, the first transistor configured to automatically switch from a conducting configuration to a non-conducting configuration, the conducting configuration for allowing signal propagation from the first terminal to the second terminal, the non-conducting configuration for preventing signal propagation from the first terminal to the second terminal;
at least one resistor connected to the third terminal of the first transistor for biasing the first transistor;
at least one diode connected to the input port for diverting a surge signal from the input port to a ground; and
a second transistor connected to the third terminal of the first transistor for controlling the switching of the first transistor from the conducting configuration to the non-conducting configuration.

2. The automatic surge sensing protection device of claim 1 wherein the first transistor is configured to automatically switch from the non-conducting configuration to the conducting configuration after the surge signal has been diverted from the input port to the ground.

3. The automatic surge sensing protection device of claim 2 wherein the first transistor is an insulated gate bipolar transistor (IGBT) and the second transistor is an IGBT.

4. The automatic surge sensing protection device of claim 3 further comprising an inductor positioned within the housing and connected to the output port and the second terminal of the first transistor.

5. The automatic surge sensing protection device of claim 4 further comprising at least one capacitor positioned within the housing and connected to the inductor for filtering electromagnetic field (EMF) effects introduced at the input port or the output port.

6. The automatic surge sensing protection device of claim 2 wherein the diode comprises a plurality of zener diodes arranged in a serial configuration.

7. The automatic surge sensing protection device of claim 1 wherein the automatic surge sensing protection device is configured as a positive polarity circuit.

8. The automatic surge sensing protection device of claim 1 wherein the automatic surge sensing protection device is configured as a negative polarity circuit.

9. An automatic surge sensing protection circuit comprising:
an input port;
an output port;
a first transistor having a first terminal, a second terminal and a third terminal, the first terminal connected to the input port and the second terminal connected to the output port, the first transistor configured to automatically switch from a conducting configuration to a non-conducting configuration, the conducting configuration for allowing signal propagation from the first terminal to the second terminal, the non-conducting configuration for preventing signal propagation from the first terminal to the second terminal;
a current divider connected to the third terminal of the first transistor for biasing the first transistor;
at least one diode connected to the input port for diverting a surge signal from the input port to a ground; and
a second transistor connected to the third terminal of the first transistor for controlling the switching of the first transistor from the conducting configuration to the non-conducting configuration.

10. The circuit of claim 9 wherein a pi filter is connected between the second terminal of the first transistor and the output port.

11. The circuit of claim 10 wherein the pi filter comprises at least one capacitor and an inductor.

12. The circuit of claim 9 wherein the current divider comprises a plurality of resistors.

13. The circuit of claim 9 further comprising a flyback diode connected between the first and second terminals of the first transistor.

14. The circuit of claim 9 further comprising a flyback diode connected between the first and second terminals of the second transistor.

15. An automatic surge sensing protection circuit comprising:
a positive input port;
a negative input port;
a positive output port;
a negative output port;
a first transistor having a first terminal, a second terminal and a third terminal, the first terminal connected to the positive input port and the second terminal connected to the positive output port, the first transistor configured to automatically switch from a conducting configuration to a non-conducting configuration, the conducting configuration for allowing signal propagation from the first terminal to the second terminal, the non-conducting configuration for preventing signal propagation from the first terminal to the second terminal;
at least one resistor connected to the third terminal of the first transistor for biasing the first transistor;
at least one diode connected to the positive input port for diverting a surge signal from the positive input port to a return conductor;
a second transistor connected to the third terminal of the first transistor for controlling the switching of the first transistor from the conducting configuration to the non-conducting configuration;
a third transistor having a first terminal, a second terminal and a third terminal, the first terminal connected to the negative input port and the second terminal connected to the negative output port, the third transistor configured to automatically switch from the conducting configuration to the non-conducting configuration;
at least one resistor connected to the third terminal of the third transistor for biasing the third transistor;
at least one diode connected to the negative input port for diverting a surge signal from the negative input port to the return conductor; and
a fourth transistor connected to the third terminal of the third transistor for controlling the switching of the third transistor from the conducting configuration to the non-conducting configuration.

16. The circuit of claim 15 further comprising a first pi filter connected between the positive output port and the ground, and a second pi filter connected between the negative output port and the ground.

17. The circuit of claim 15 wherein the return conductor is connected to a ground.

18. The circuit of claim 15 further comprising a flyback diode connected between the first and second terminals of the first transistor.

19. The circuit of claim 15 further comprising a flyback diode connected between the first and second terminals of the third transistor.

20. The circuit of claim 15 further comprising a first capacitor connected between the positive input port and the return conductor, and a second capacitor connected between the negative input port and the return conductor.
